(19) United States
(12) Patent Application Publication
(10) Pub. No.: US 2010/0015320 A1
(43) Pub. Date: Jan. 21, 2010

(54) Natural sugar replacement and process for preparing the same

(75) Inventor: Thomas J. King, Portland, CA (US)

Correspondence Address: Imani M Wesley, P.O. Box 99144, Emeryville, CA, 94662, US

(73) Assignee: STEVIVA BRANDS, INC., Portland, OR (US)

(21) Appl. No.: 12/503,912

(22) Filed: Jul. 16, 2009

Related U.S. Application Data
(60) Provisional application No. 61/135,270, filed on Jul. 18, 2008.

(51) Int. Cl. A23L 1/221; A23P 1/02

(52) U.S. Cl. 426/650; 426/453

(57) ABSTRACT

A natural sweetener composition for oral consumption, for replacing sugar, comprising Stevia extract and at least one additive selected from the group comprising fructooligosaccharides, fructose, magnesium carbonate, and combinations thereof. Also provided is a method for preparing natural sweetener compositions for oral consumption comprised of Stevia extract with certain additives.

### CROSS-REFERENCE TO RELATED APPLICATION

This application claims the priority benefit of U.S. Provisional Application No. 61/135,270, filed on Jul. 18, 2008 by the present inventor, which is incorporated herein by reference.

### BACKGROUND OF THE INVENTION

1. Field of Invention

This application is directed to natural sweetener compositions for oral consumption comprising Stevia extract with a plurality of other ingredients, and to a process for preparing the same.

2. Description of Related Art

Sucrose is commonly known as table sugar and results from the linkage of two monosaccharides, glucose and fructose. Monosaccharides, the most basic unit of carbohydrates, are the simplest form of sugar.

Sugar (sucrose) is widely used as a sweetener for beverages, food, and other edible products. It is used because of its sweetness, full-bodied taste, water retentivity, ability to give thickness and the like. The properties of sugar also allow for camelizing and browning which makes sugar preferred for baking. However, since sugar consists of glucose sugars, blood sugar levels can be raised.

There has been an increased awareness in recent years about the unhealthy effects of sugar intake and excess sugar consumption. Vast numbers of consumers seek sweet but healthy alternatives to sugar. In particular, some seek alternatives that do not have unhealthy consequences such as tooth decay, obesity, and health complications related to being overweight and obese (e.g., type 2 diabetes, hypertension, hypertriglyceridemia, and heart disease).

As a result, replacements for sugar having intense sweetness have been studied and developed, including natural sweeteners. Among these natural sweeteners are formulations prepared from plant materials, such as, for example, Stevia extracts. Stevia, derived from a South American plant called Stevia rebaudiana Bertoni, is intensely sweet with a bitter, licorice-like aftertaste which is unpleasant to some. Accordingly, ways to accentuate and improve the taste of Stevia have been explored.

For example, U.S. Pat. No. 7,267,835 describes a sweetener composition containing steviol glucosides comprising .beta.-1,4-galactosyl rebaudioside A having one to three .beta.-1,4-bonded galactosyl groups in a molecule and rebaudioside A. Such sweetener compositions are prepared by allowing a .beta.-1,4-galactosyl transferase to react on an aqueous solution containing a Stevia extract containing 40% by weight or more of rebaudioside A and a .beta.-1,4-galactosyl sugar compound (specifically lactose) in a 5- to 20-fold amount based on the solid content of the Stevia extract. The resultant sweeteners are described as having mild sweetness like sugar while maintaining a high sweetness intensity of a Stevia sweetener.

However, for persons who are unable to digest significant amounts of lactose (i.e., lactose intolerant), the resultant sweeteners, which necessarily require lactose, are insufficient sugar replacements.

U.S. Pat. No. 7,229,658 discloses sweetener compositions combining sucralose with other sweet substances such as fructose and Stevia extract. The disclosed sweeteners are characterized as having mitigating effects on the rough tastes and lingering sweet aftertastes of the sucralose or other sweeteners, resulting in sweetening compositions having rich and full-bodied sweetness.

While sucralose is a high intense sweetener, it is an artificial sweetener. Hence, the need for high intense, natural sweeteners remains.

### SUMMARY OF INVENTION

An objective herein is to provide natural sweetener compositions for oral consumption that comprise Stevia extract, having similar characteristics as sugar, negligible affects on insulin and blood glucose levels, and which are low in calories and carbohydrates.

A further aim is to provide natural sweetener compositions for oral consumption suitable for use by persons with diabetes and other blood sugar-related illnesses, as well as persons on carbohydrate-controlled diets.

Another objective is to provide a process for preparing natural sweetener compositions for oral consumption, the process comprising mixing and drying Stevia extract with a plurality of other ingredients.

In the following descriptions, natural sweetener compositions for oral consumption and the process for preparing the same are specifically exemplified. However, it is to be understood that the disclosures herein are not limited to any particular example or embodiment. Rather, the spirit and scope of the embodiments are set forth in the appended claims.

### DETAILED DESCRIPTION OF EMBODIMENTS

In this specification, a natural sweetener composition for oral consumption means a product which is taken orally and also a product which is used in the mouth. Natural sweetener compositions for oral consumption include but are not limited to sweeteners to sweeten hot and cold beverages, and food; spices, seasonings and like food preparations, in dry and liquid forms; food including confections and beverages; oral medicines including coated tablets, drops, sprays and syrups taken and used in the mouth; and mouth sprays and like oral refreshment, mouthwashes, gargles and dentifrices and the like for oral sterilization or oral cleansing.

Also in this specification, agglomerating means putting powder through an agglomeration process.

The present inventor studied for years to provide natural sweetener compositions for oral consumption that use and minimize the bitterness and aftertaste of Stevia. The present inventor also studied to provide alternatives that do not add calories, carbohydrates, or have a glycemic impact while having sugar-like characteristics, such as usability, taste, and the ability to brown and caramelize. It was found that such natural sweetener compositions for oral consumption can be obtained by combining Stevia extract with a plurality of other ingredients, including fructooligosaccharides, fructose, and magnesium carbonate.

Described herein are natural sweetener compositions for oral consumption comprising Stevia extract and at least one additive. In accordance with one embodiment, a natural sweetener composition for oral consumption comprises Stevia extract, fructooligosaccharides, fructose, and magnesium carbonate.

Stevia extract is used to bring the total sweetness factor of the resulting sweetener composition for oral consumption to approximately twice as sweet as sugar. Stevia is a calorie-free, high intense natural sweetener. It is derived by extracting the sweet constituents from the leaves of Stevia plants, and it ranges in sweetness from 40 to 300 times sweeter than sugar.

The sweet constituents in Stevia extract include Stevioside, Rebaudioside A, Rebaudioside B, and Rebaudioside C. Stevioside and Rebaudioside A, the primary compounds in Stevia extract, are heat stable, pH stable, and do not ferment. Also, they do not induce a glycemic response when ingested. Rebaudiosides B and C are negligible to the sweetness affect of Stevia.

The use of Stevia extract having less than 85 percent by weight of Stevioside and at least about 60 percent by weight of Rebaudioside A, presently, is not preferred, as doing so diminishes the efficacy of the resulting natural sweetener composition for oral consumption, as it will result with a bitter, non-sweet aftertaste.

In one embodiment, the concentration of Stevia extract, in dry form, is at least about 0.5 percent by weight of the resulting composition, whereby the percent by weight of Stevioside is at least about 1.4 times greater than the percent by weight of Rebaudioside A. Stevia extract having at least about 95 percent by weight of Stevioside and at least about 60 percent by weight of Rebaudioside A is optimal. Negligible amounts of Rebaudiosides B and C may be included.

Fructooligosaccharides (hereinafter FOS) are fine fruit fibers and are used to aid digestion. FOS increases calcium absorption and promotes the growth of intestinal bacteria. Nutritionally, FOS is considered a form of soluble fiber and is sometimes seen as a prebiotic.

FOS is extracted from fruits and vegetables including but not limited to bananas, onions, chicory root, garlic, asparagus, barley, wheat, jícama, tomatoes, leeks, the Jerusalem artichoke, and yacón. FOS has a minimal impact on blood sugar, and does not raise triglycerides.

In one embodiment, the concentration of FOS, in dry form, is about 2 percent by weight of the resulting natural sweetener composition for oral consumption. Using more than 2 percent FOS or less than 2 percent FOS is presently not preferred, as doing so can diminish the efficacy of the resulting composition. Too much FOS can lead to gas and bloating, and having none or too little FOS eliminates the beneficial impact FOS has of aiding digestion.

Fructose aids in balancing the high intense sweetness of Stevia. Fructose is a simple reducing sugar (monosaccharide) found in many foods and is an important dietary monosaccharide. It is neutral on the glycemic index and has many of the same characteristics as sugar without as many calories and carbohydrates. It does not affect blood sugar levels. Fructose is approximately 70% as sweet as sugar.

In one embodiment, the concentration of fructose, in dry form, is about 95 percent by weight of the resulting natural sweetener composition for oral consumption.

The use of other sugars (such as other monosaccharides and disaccharides) is not preferred presently because they affect insulin and blood glucose levels and may also present gastrointestinal side effects. For example, glucose and sucrose affect insulin levels and are not neutral on the glycemic index. Also, lactose is problematic for lactose intolerant persons, as they may likely have problems with digestion.

Magnesium carbonate is used for binding and to prevent clumping. Magnesium carbonate (hereinafter MgCO₃) is an all natural mineral that aids in the digestion of Calcium.

In one embodiment, the concentration of MgCO₃, in dry form, is about 2.5 percent by weight of the resulting natural sweetener composition for oral consumption.

It is presently not preferred to use high concentrations of MgCO₃ because doing so can have a laxative-like impact. Additionally, adding too much MgCO₃ leaves a residue.

This application also provides a process for preparing natural sweetener compositions for oral consumption. The present inventor has discovered this process to be optimal for preparing natural sweetener compositions for oral consumption, as disclosed herein. This process for preparing natural sweetener compositions for oral consumption disclosed herein is not specifically limited but is presently preferred, said process comprising: making a slurry, drying the slurry, and agglomerating the dried slurry.

Making a slurry comprises mixing Stevia extract, pure water, and at least one additive, selected from the group comprising fructose, fructooligosaccharides (FOS), and magnesium carbonate. Making a slurry further comprises:
Combining 95 parts of crystalline fructose with 2 parts FOS in dry form;
Blending said fructose and FOS in a double ribbon blender at least at 25 RPM for a minimum of 3 minutes;
Adding 0.5 parts Stevia extract, 2.5 parts magnesium carbonate, and pure water to previously blended fructose and FOS parts; and
Blending all parts at least at 25 RPM for a minimum of 5 minutes until a well mixed slurry results.

It is not critical that a ribbon blender be used but it is the most effective.

Drying the slurry comprises spray drying the completely mixed slurry until it is in powder form of at least about 100 microns.

Spray drying is a method of producing a dry powder from a liquid or slurry by rapidly drying with a hot gas. This is the preferred method of drying of many thermally sensitive materials such a food and pharmaceuticals.

A consistent particle size distribution is a reason for spray drying some industrial products. All spray dryers use some type of atomizer or spray nozzle to disperse the liquid or slurry into a controlled drop size spray. The most common of these are rotary nozzles and single-fluid pressure swirl nozzles. Alternatively, for some applications, two-fluid or Ultrasonic Nozzles are used. Depending on the process needs, drop sizes from 10 to 500 micron can be achieved with the appropriate choices. The most common applications are in the 100 to 200 micron diameter range.

As the slurry enters the tower of the spray dryer, it is atomized. Partly because of the high surface tension of water and partly because of the hydrophobic/hydrophilic interactions between the amphipathic carrier, the water, and the load, the atomized slurry forms micelles. The small size of the drops (averaging 100 micrometers in diameter) results in a relatively large surface area which dries quickly. As the water dries, the carrier forms a hardened shell around the load.

Agglomerating the dried slurry comprises:
Moistening the powder form of the dried slurry; and
Drying and cooling the moistened granulates until the resulting powder is in at least about 300 micron granules.

Agglomeration in the fluid bed is a modern process for building up powder granulates. In this process, powder is moistened in order to form liquid bridges between the particles. The spray liquid can either be water or an organic solvent, a powder dissolved in water or another binder. The moistened granulates are dried and cooled as required. Due to the relatively low mechanical forces in the fluid bed, the agglomerates/granulates are loose, have a low bulk density and are outstandingly soluble in water. This agglomeration process optimizes the consistency of resulting natural sweetener compositions for oral consumption.

What is claimed is:

1. A natural sweetener composition for oral consumption comprising Stevia extract and at least one additive.

2. The composition according to claim 1, wherein said Stevia extract comprises Stevioside, Rebaudioside A, Rebaudioside B, and Rebaudioside C.

3. The composition according to claim 2, wherein said Stevia extract comprises Stevioside and Rebaudioside A, whereby the percent by weight of Stevioside is at least about 1.4 times greater than the percent by weight of Rebaudioside A.

4. The composition according to claim 3, wherein the concentration of said Stevia extract is at least about 0.5 percent by weight of the resulting natural sweetener composition for oral consumption.

5. The process according to claim 1, wherein said additives comprise fructose, fructooligosaccharides (FOS), and magnesium carbonate.

6. The composition according to claim 5, wherein the concentration of said fructose is about 95 percent by weight of the resulting natural sweetener composition for oral consumption.

7. The composition according to claim 5, wherein the concentration of said fructooligosaccharides is about 2 percent by weight of the resulting natural sweetener composition for oral consumption.

8. The composition according to claim 5, wherein the concentration of said magnesium carbonate is about 2.5 percent by weight of the resulting natural sweetener composition for oral consumption.

9. A process for preparing natural sweetener compositions for oral consumption comprising:
making a slurry;
drying the slurry; and
agglomerating the dried slurry.

10. The process according to claim 9, wherein making a slurry comprises mixing Stevia extract, pure water, and at least one additive, selected from the group comprising fructose, fructooligosaccharides (FOS), and magnesium carbonate.

11. The process according to claim 10, wherein making a slurry further comprises:
Combining 95 parts of crystalline fructose with 2 parts FOS in dry form;
Blending said fructose and FOS in a blender at least at 25 RPM for a minimum of 3 minutes;
Adding 0.5 parts Stevia extract, 2.5 parts magnesium carbonate, and pure water to previously blended fructose and FOS parts; and
Blending all parts at least at 25 RPM for a minimum of 5 minutes until a well mixed slurry results.

12. The process according to claim 9, wherein drying the slurry comprises spray drying the completely mixed slurry until it is in powder form of at least about 100 microns.

13. The process according to claim 9, wherein agglomerating the dried slurry comprises:
Moistening the powder form of the dried slurry; and
Drying and cooling the moistened granulates until the resulting powder is in at least about 300 micron granules.
